(19) United States
(12) Patent Application Publication
(10) Pub. No.: US 2024/0211400 A1
(43) Pub. Date: Jun. 27, 2024

(54) DISAGGREGATING A MEMORY SIDE CACHE DATA ARRAY AND CACHE CONTROLLER

(71) Applicant: Intel Corporation, Santa Clara, CA (US)

(72) Inventors: Israel Diamand, Aderet M (IL); Randy B. Osborne, Beaverton, OR (US); Aravindh V. Anantaraman, Folsom, CA (US); Nadav Bonen, Ofer Z (IL)

(21) Appl. No.: 18/069,249

(22) Filed: Dec. 21, 2022

(51) Int. Cl. G06F 12/0815

(52) U.S. Cl. CPC G06F 12/0815; G06F 2212/1024

(57) ABSTRACT

In one embodiment, a semiconductor package comprises: a first die comprising: a plurality of cores; and memory circuitry comprising a memory controller and a memory side cache controller to maintain tag information and state information for a data array; and a second die coupled to the first die, the second die comprising the data array to cache data for at least one accelerator, the at least one accelerator remote from the first die. The memory side cache controller may be configured to control the data array. Other embodiments are described and claimed.

### BACKGROUND

Modern processors include processing engines such as cores or other intellectual property (IP) circuits and one or more cache memories to store frequently and/or recently accessed information. Accessing information closely located with consuming circuits reduces latency and increases processor speeds.

Some platforms provide a so-called memory side cache, in which the cache memory is closely coupled with a memory. This memory side cache can reduce access latency in many cases; however, more remote data consumers such as non-core data consumers may incur greater latencies and more complexity when seeking data present in the memory side cache.

### BRIEF DESCRIPTION OF THE DRAWINGS

FIG. 1A is a block diagram of an SoC in accordance with an embodiment.

FIG. 1B is a block diagram of an SoC in accordance with another embodiment.

FIGS. 2A-C are block diagrams showing transaction flows in accordance with embodiments.

FIG. 3 is a flow diagram of a method in accordance with an embodiment.

FIG. 4 is a flow diagram of a method in accordance with another embodiment.

FIG. 5 illustrates an example computing system.

FIG. 6 illustrates a block diagram of an example processor and/or System on a Chip (SoC) that may have one or more cores and an integrated memory controller.

FIG. 7(A) is a block diagram illustrating both an example in-order pipeline and an example register renaming, out-of-order issue/execution pipeline according to examples.

FIG. 7(B) is a block diagram illustrating both an example in-order architecture core and an example register renaming, out-of-order issue/execution architecture core to be included in a processor according to examples.

FIG. 8 illustrates examples of execution unit(s) circuitry.

FIG. 9 is a block diagram of a register architecture according to some examples.

FIG. 10 is a block diagram illustrating the use of a software instruction converter to convert binary instructions in a source instruction set architecture to binary instructions in a target instruction set architecture according to examples.

FIG. 11 is a cross sectional view of a package in accordance with an embodiment.

FIG. 12 is a block diagram of a scalable integrated circuit package in accordance with an embodiment.

### DETAILED DESCRIPTION

In various embodiments, a system on chip (SoC) or other processor may be configured with a distributed memory side cache that physically disaggregates a controller for the memory side cache from a data array of the memory side cache. In this way, the controller for the memory side cache (and associated array(s) for tag and state information) may be physically located close to a memory subsystem. In turn, a large data array of the memory side cache may be physically located close to intellectual property (IP) circuitry to reduce access latencies. And as described herein, in many embodiments these two portions of a memory side cache can be located on different semiconductor dies.

In a given processor or other SoC, there are various core memories. For example, there are various levels of core caches including a level one (L1), mid-level cache (MLC), and last level cache (LLC) that are used to cache data of the cores. Other IP circuits may snoop those caches when seeking access to a coherent memory. Similarly, any IP circuit can have a cache, which although primarily for its own usage, can be snooped by other IP circuits to obtain the most updated data (for a read) or invalidate the cache data (for a write). Coherency circuitry such as a home agent is responsible for coherency between core and IP-side caches. IP circuits may access a memory subsystem directly if hardware coherency is not implemented (e.g., if coherency is achieved by software means).

In addition to these core/IP caches, systems can include a memory side cache (MS$) as part of a memory subsystem. Data cached in the MS$ can be of any core or IP circuit. With a MS$, requests traverse through the MS$ before going to the memory. The MS$ is typically invisible to software. Data that is written to the MS$ is assumed to be written to memory (since cores/IP circuits lookup the MS$ before reading from memory).

In addition to this physical arrangement, embodiments provide a cache access protocol such that most data transfers are done locally and directly between the IP circuitry and the cache data array, while the memory side cache controller is configured to handle only low-weight request and response messages.

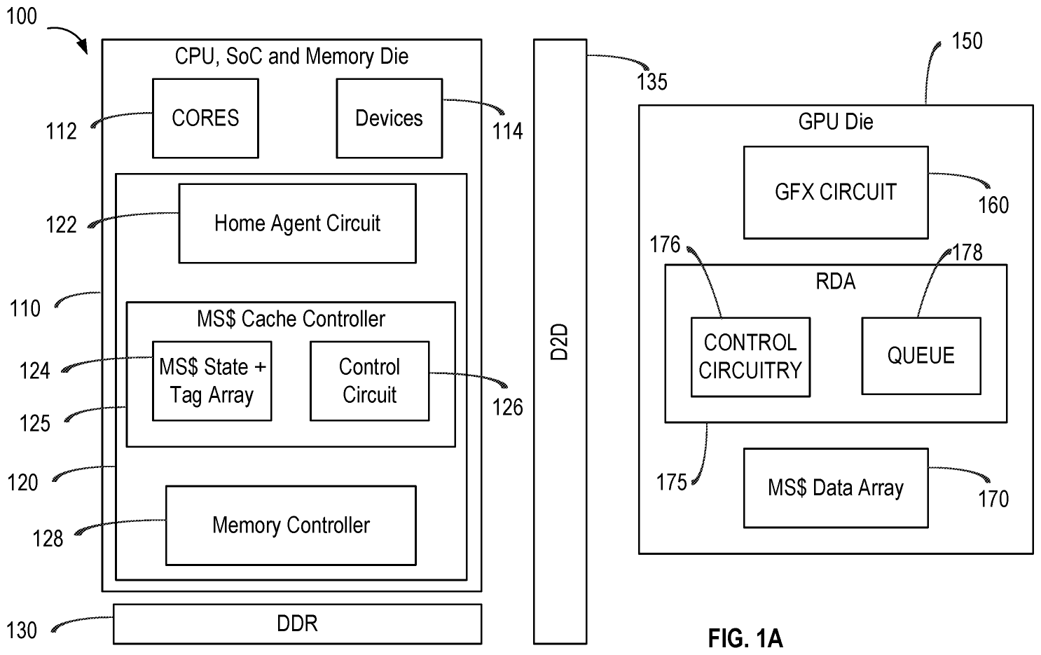

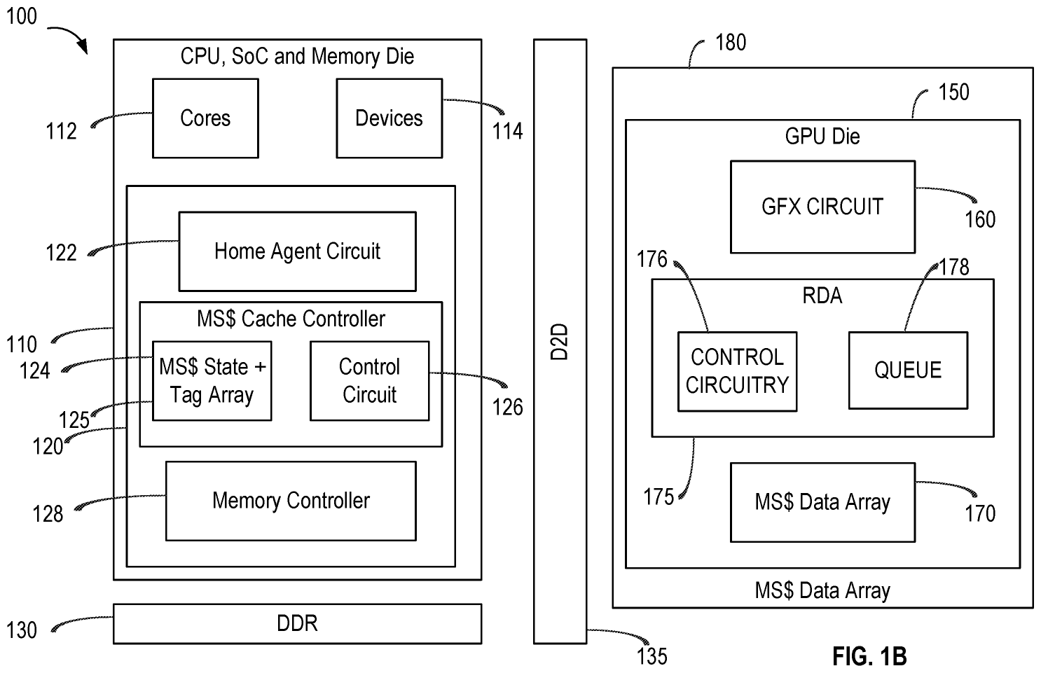

Referring now to FIG. 1A, shown is a block diagram of an SoC in accordance with an embodiment. As shown in FIG. 1A, SoC 100 is implemented as a multi-die package. In this particular implementation, SoC 100 includes at least a first die 110 and a second die 150. In general, first die 110 is implemented as a primary compute die and may include central processing unit (CPU) circuitry, SoC circuitry and memory subsystem-related circuitry. In turn, second die 150 may be implemented as a graphics processing unit (GPU) die.

First die 110 includes a plurality of cores 112. In different implementations, the cores may be homogenous or heterogenous. For example, in a heterogenous implementation one or more first core types and one or more second core types, at least, may be present. In an example, the first core type may be a performant core type while the second core type may be a power efficient core type. In this way, appropriate tradeoffs between power and performance may be realized. As further shown in FIG. 1A, first die 110 also includes one or more devices 114. In different implementations devices 114 may include accelerator circuits, specialized processing units, or so forth, along with associated peripheral circuitry of the SoC.

First die 110 also includes a memory subsystem 120. In the high level shown in FIG. 1A, memory subsystem 120 includes a home agent circuit 122 which may be configured to perform coherency operations and act as a home agent for cores 112 and devices 114. Memory subsystem 120 also includes a memory controller 128, which acts as a control circuit with respect to a system memory 130 (which may be implemented in a separate package from SoC 100). In the embodiment of FIG. 1A, system memory 130 may be implemented as double data rate (DDR) memory such as a given dynamic random access memory (DRAM).

Still referring to memory subsystem 120, also included is a memory side cache controller 125. As will be described herein, cache controller 125 is disaggregated from a data array of a memory side cache. As shown, cache controller 125 includes a control circuit 126 and a state and tag array 124 which may maintain tag addresses and associated state for data present in the data array of the memory side cache. The state information may indicate a cache coherency state of a given cacheline. For example, in a MESI protocol, cachelines may be in a given one of a Modified (M), Exclusive (E), Shared (S) or Invalid (I) state. Although a single array is shown for ease of illustration in FIG. 1A, array 124 may be implemented with separate arrays for state and tags.

Still with reference to FIG. 1A, first die 110 couples to second die 150 via a die-to-die (D2D) interface 135. In various embodiments, interface 135 may be implemented as a plurality of interconnects adapted on a substrate of SoC 100 to couple pads or other contacts of first die 110 with corresponding pads or other contacts of second die 150. In a particular embodiment, D2D interface 135 may be implemented as an Intel® Ultra Path Interconnect (UPI), a Compute Express Limited (CXL) or other standard or proprietary interconnect via with agents on the dies can communicate.

Referring now to second die 150, a graphics (GFX) circuit 160 is present. In various embodiments, graphics circuit 160 may be implemented as a graphics processing unit (GPU) including a plurality of graphics processing cores, which may include homogenous or heterogenous graphics core types. In other implementations, another type of processing circuitry (generically XPU circuitry) may be present. In any event as further illustrated, second die 150 also includes a data array 170 of the memory side cache. Although embodiments are not limited in this regard, in one example data array 170 may be many tens of megabytes (MBs).

As further shown, coupled to data array 170 is a remote data agent (RDA) 175 that may be implemented as a relatively basic microcontroller to act as a remote control agent for memory side cache controller 125. In the high level shown in FIG. 1A, RDA 175 includes control circuitry 176 and one or more queues 178 to store data of transactions between data array 170 and GFX circuit 160. With embodiments, cache memory communications between memory side cache controller 125 and RDA 175 may occur via a mainband of D2D interconnect 135.

More generically, second die 150 may be considered an IP die including some type of IP circuitry and a corresponding data array, namely, a data array of a memory side cache that is managed remotely by a remote memory side cache controller. Although shown at this high level in the embodiment of FIG. 1A, many variations and alternatives are possible. For example, in other cases a single die implementation may provide a memory side cache that is remote with respect to a CPU portion of the die (and closely located with one or more IP circuits) to reduce amount of data transactions.

For example, in other cases, instead of providing a second (or more) die having IP circuitry and associated data arrays of one or more memory side caches, it is possible to provide a data array of a memory side cache on a separate die that is closely coupled with an IP die. Referring now to FIG. 1B, shown is a block diagram of an SoC in accordance with another embodiment. In FIG. 1B, SoC 100′ may be implemented substantially the same as SoC 100 in FIG. 1A. However, in this implementation another die 180 is present. Third die 180 may be a standalone data array that can be many times larger than a data array co-located on a die with IP circuitry. For example, the data array present on third die 180 may be hundreds of MBs to many gigabytes (GBs). In the embodiment shown, second die 150 may be stacked above or beyond third die 180 in a 3D stacking arrangement. In other aspects, SoC 100′ may be implemented as discussed above with regard to FIG. 1A. Also note that while in FIG. 1B, the MS$ data array is shown as being distributed with a portion present (as data array 170) on second die 150 and a larger portion present on third die 180, in other cases data array 170 may not be present on second die 150. Depending on implementation, RDA 175 may be implemented on second die 150 or third die 180. Thus while FIG. 1B presents structurally a different implementation, the same distributed and disaggregated memory side cache control of a data array is realized.

Embodiments further provide protocol flows to more efficiently execute cache operations to read and write the data array of the memory side cache. With embodiments, at least certain data transfers between dies may be saved as compared to a conventional memory side cache with aggregated memory side cache controller and data array. More specifically, for a read request an RDA may directly return data obtained from a memory side data array to an IP requester. In the case of a memory side cache miss, a memory read and memory side cache fill occurs. In an embodiment, the memory side cache controller in the CPU die reads data from memory and sends the data to the RDA, which in turn performs a data return to the requesting IP circuitry and performs the data fill to the data array. In the case of a data writeback from IP circuitry, the RDA may pull the data from the IP circuitry and directly write the data to the memory side cache, without any data transfers between the dies.

In one or more embodiments, the RDA may be configured to: receive cache commands from the main cache controller; schedule read and write commands to the cache data array; return read data and pull write data to/from IP circuitry; and (optionally) maintain array technology requirements such as banking rules, refresh, and array timing.

In one or more embodiments, the RDA may be configured to communicate via multiple protocols. For communication between the memory side cache controller and the RDA, an underlying memory access protocol of a mainband communication protocol may be used (e.g., CXL.mem in a common fabric interface in one example). In some embodiments, additional cache commands may be sent from the memory side cache controller to the RDA, namely, a Read_From_Cache_And_Forward_Data_To_IP (which causes a read-hit operation as described above), and a Write_Data_To_Cache_And_Forward_Data_To_IP (which causes a read-miss-fill operation as described above), and a Pull_Data_From_IP_And_Write_To_Cache (for a write case).

Note that in one or more embodiments, for these cache commands the memory side cache controller sends a cache address rather than a physical address. Incoming memory requests from the IP circuit may include a logical address. The memory side cache controller translates this address to a cache address, e.g., by combining a cache set and way. In turn, the RDA may communicate with the IP circuit using the IP circuit's native language (e.g., for GFX circuitry the protocol can be iCXL). In this way, the communication protocol of the IP circuit is not affected. In fact, the RDA is not visible as a separate device to the IP circuit, which does not know that it communicates with the RDA and not the memory side cache controller (and in fact, the MS$ itself is not visible to the IP circuit).

In a conventional cache, a cache controller knows when a read or a write is completed since the data array is local. With embodiments, the RDA does not independently identify completion, which may lead to ordering issues. For example, a read-hit is handled by the RDA. Before the read is completed, the memory side cache controller de-allocates the cacheline, and then could re-allocate the same cacheline to another physical address, and send a write/fill request through the RDA (triggering a Write-After-Read hazard). Another situation may be where a write or fill command is handled by the RDA. Before the write is completed, the memory side cache controller may receive a read command to the same physical address, and could send a read command to RDA (triggering a Read-After-Write hazard).

In one embodiment, ordering may be maintained between the commands that are sent to the RDA for the same cache address. Such ordering may be implemented on an interconnect and in RDA queues. This ordering may include commands that are sent to the RDA on different channels (e.g., Request and Data), which may raise complexity. Depending on implementation, there can be different queue implementations, e.g., a shared read/write queue or separated queues.

In another embodiment, the RDA may be configured to send a completion (CMP) message back to the memory side cache controller when an operation is done. However, occupancy of requests in the memory side cache controller may increase with a corresponding increase in its queue size.

In yet another embodiment, a combination of techniques may be used to maintain ordering. For example, the RDA may send a CMP message immediately when a command is sampled by the RDA. In addition, the RDA may be configured to maintain ordering within the RDA queues. In this way, there are no fabric ordering requirements, and a smaller memory side cache tracker can be used.

In some agent protocols (such as IDI, iCXL), a bogus indication may be sent when the agent holds modified data and is in the process of writing the data back to the memory subsystem, but the data is snooped (e.g., due to access from another IP circuit) before the writeback is serviced. In this case the agent provides the data as a snoop response, and it marks the writeback as bogus, so the next level cache (or coherent agent) knows that write is redundant. In conventional memory side cache systems, a write-pull is sent to the agent before memory side cache lookup, so in case of bogus writeback the lookup is skipped.

In one or more embodiments, the memory side cache controller may be looked up and a way selected before the write-pull command is sent through the RDA. In this case, if the writeback becomes bogus, there may be stale data in the memory side cache. To resolve this concern, when the RDA receives a bogus indication (with the write data message), it may skip the data array data write, and send a bogus indication along with the CMP message back to memory side cache controller. In turn, the memory side cache controller may revert the cache to the previous state as if the write would not occur. This means that since a cacheline was allocated for that writeback, the memory side cache controller invalidates that entry.

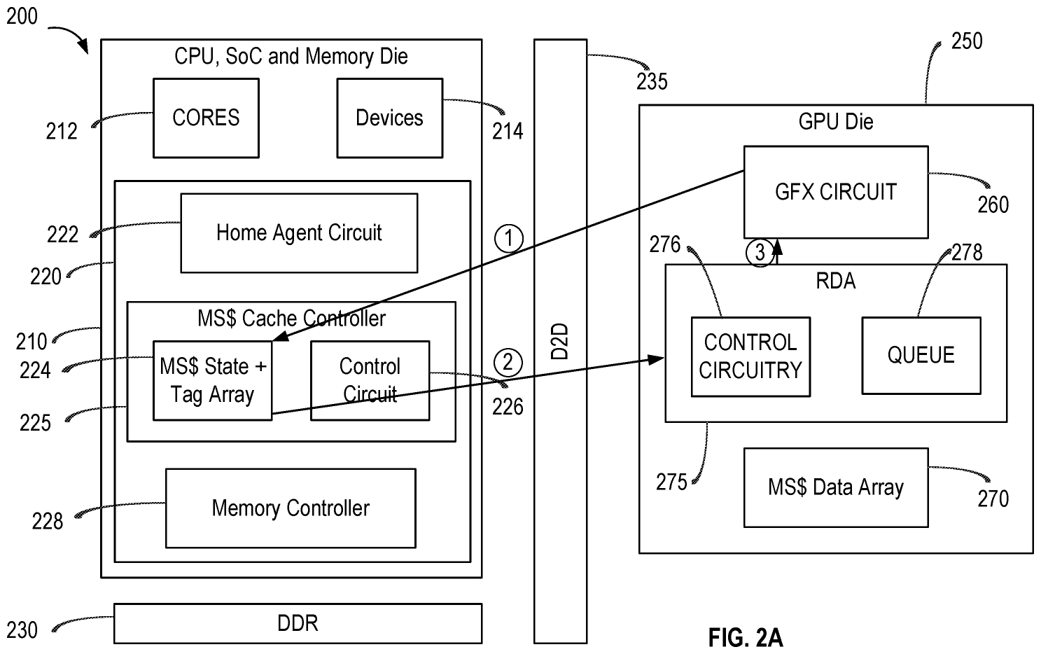

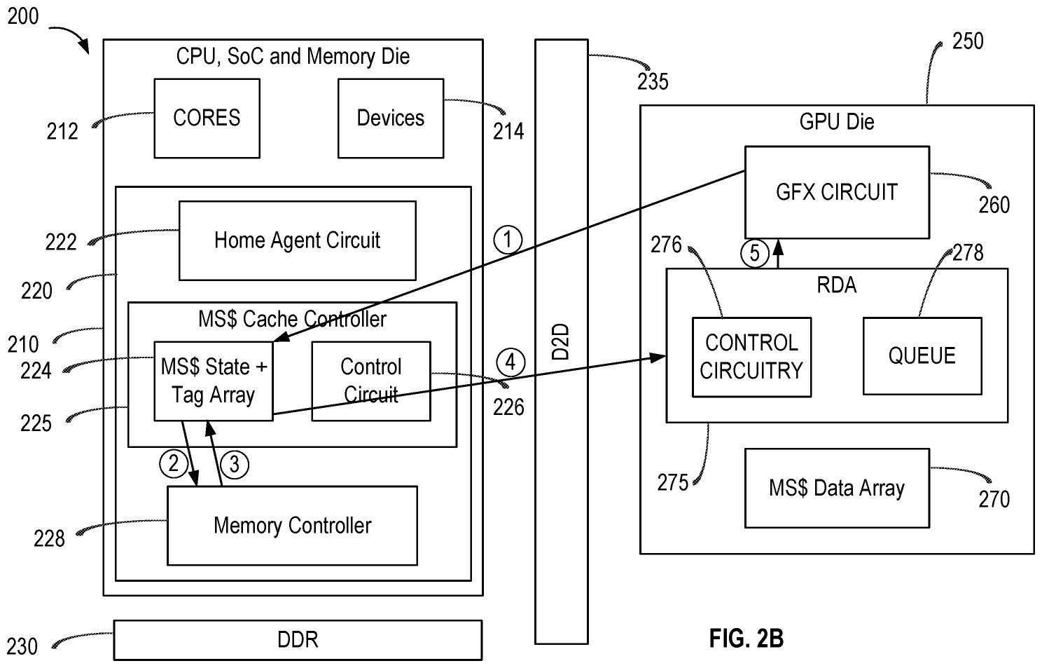

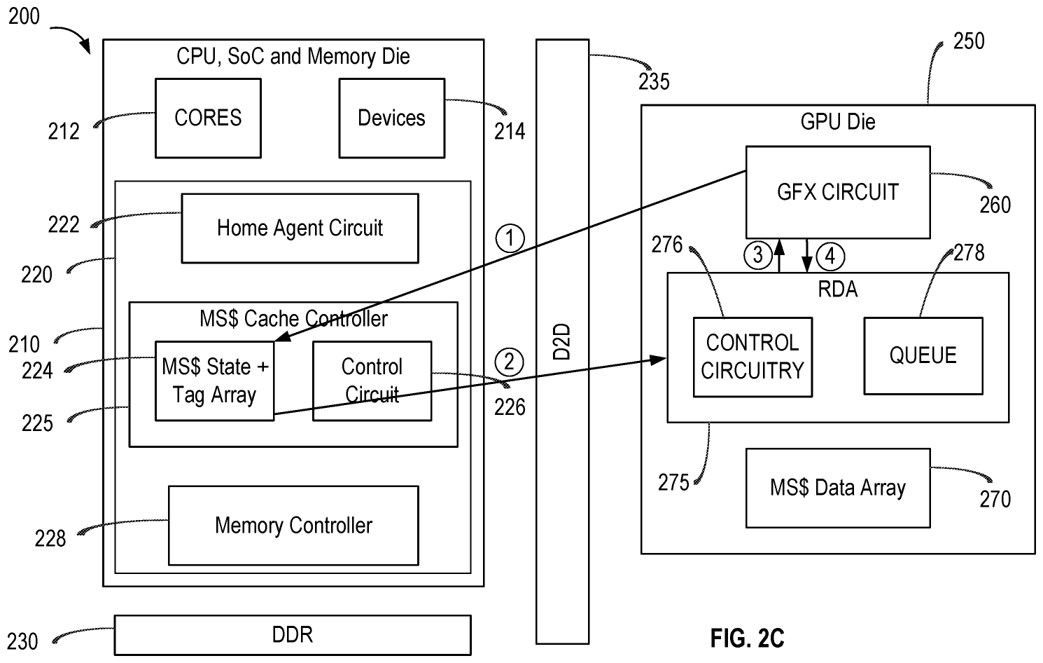

Referring now to FIGS. 2A-2C, shown are diagrams illustrating representative memory side cache flows in accordance with an embodiment. As shown in FIG. 2A, which represents the same SoC as illustrated in FIG. 1A, in the case of a read flow with a memory cache hit, the transaction flow is as shown. Specifically, a read request (enumerated as message 1) is issued from graphics circuit 160 and is sent to memory side cache controller 120. In turn, based on a hit in the tag/state array 124, memory side cache controller 120 sends a read and forward command to RDA 175 (enumerated as message 2). In response to this command, RDA 175 reads the data from data array 170 and provides the data directly to graphic circuit 160 (enumerated as message 3).

As shown in FIG. 2B, in the case of a memory side cache miss, a memory read flow occurs with a corresponding memory side cache fill. Thus, in this situation memory side cache controller 125 identifies that the requested data (sent in message 1) is not present in data array 170 (based on state/tag array 124). As such, memory side cache controller 125 issues a read request (enumerated as message 2), via memory controller 128, to memory 130. In response the returned data (received in message 3) is sent to RDA 175 (enumerated as message 4) for a fill and data return. As such, RDA 175 returns the received data to graphic circuitry 160 (enumerated as message 5) and also writes the data into data array 170.

As shown in FIG. 2C, for a writeback operation, the data is written directly into data array 170. As illustrated, graphics circuitry 160 sends a write request (enumerated as message 1). Whether a cache hit or miss, memory side controller 125 determines to allocate the cacheline into data array 170. In response to this request, memory side cache controller 125 sends a write pull command (enumerated as message 2) to RDA 175 to cause it to pull the data directly from graphic circuitry 160 (enumerated as message 3) and write it into data array 170 (enumerated as message 4). Although shown with these high-level flows in FIGS. 2A-2C, understand that variations and alternatives are possible.

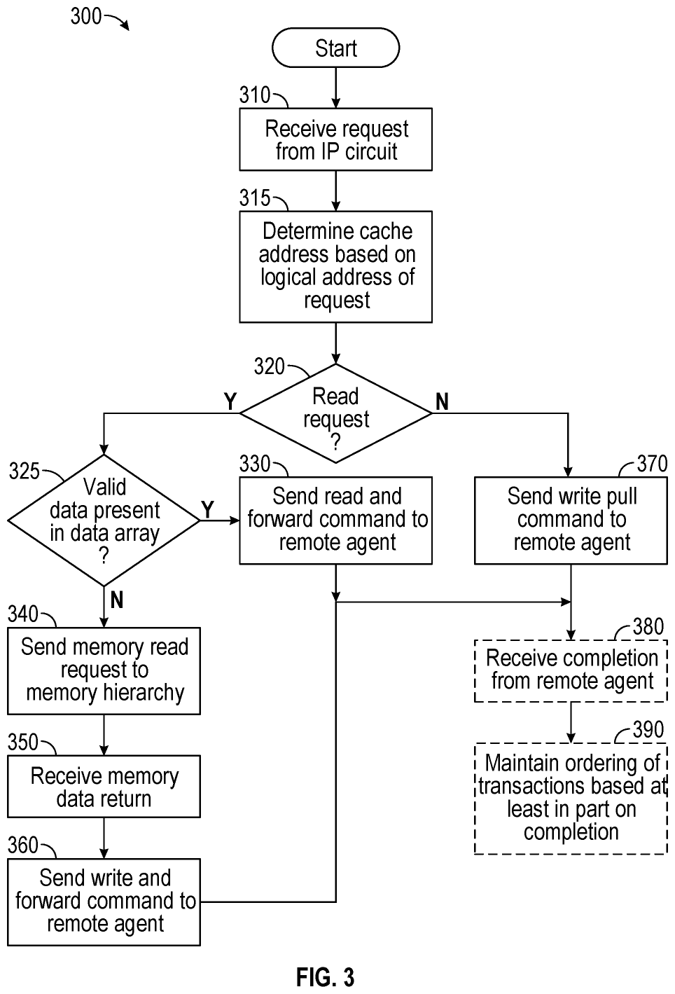

Referring now to FIG. 3, shown is a flow diagram of a method in accordance with an embodiment. More specifically, method 300 of FIG. 3 is a method for handling incoming requests in a memory side cache controller in accordance with an embodiment. As such, method 300 may be performed by hardware circuitry, e.g., the memory side cache controller alone and/or in combination with firmware and/or software.

As illustrated, method 300 begins by receiving a request from an IP circuit (block 310). This request may be received via an inter-die interconnect, e.g., according to a memory protocol for the interconnect. Next at block 315, a cache address may be determined based on a logical address of the request. For example, the memory side cache controller may determine a Set and Way based on the logical address. Next it is determined whether the incoming request is a read request (diamond 320). If a read request, control passes next to diamond 325 to determine whether valid data is present in the data array (namely a hit). This determination may be based on access to a state/tag array. If a valid hit is determined, control passes to block 330 where a read and forward command is sent to a remote agent, such as the RDA described herein.

Otherwise, if there is no hit, the memory side cache controller, at block 340, sends a memory read request to a memory hierarchy (e.g., to a DRAM or other system memory). Next at block 350, a memory data return is received, and the memory side cache controller sends (at block 360) a write and forward command to the remote agent, to cause it to provide the data to the IP circuit requester and to further write the data into the data array.

Still with reference to FIG. 3, instead if the incoming request is a write request, control passes to block 370 where the memory side cache controller sends a write pull command to the remote agent. In response to this command, the RDA obtains the writeback data from the IP circuit in response to a pull command and writes the data into the data array. Note that this allocation into the data array is an optional decision of the memory side cache controller. It can also decide not to allocate the cacheline to the cache, and just return the data directly to the requestor (in which case the RDA is not involved).

Still referring to FIG. 3, in optional implementations, the memory side cache controller may further receive a completion from the remote agent, indicating a successful completion of the cache command (block 380). In these situations, the memory side cache controller may maintain ordering of transactions based at least in part on this completion (block 390).

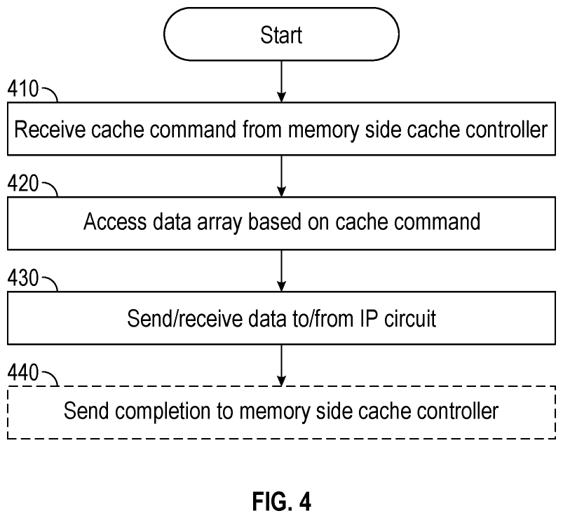

Referring now to FIG. 4, shown is a flow diagram of a method in accordance with another embodiment. More specifically, method 400 of FIG. 4 is a method for handling incoming cache commands in a remote data agent in accordance with an embodiment. As such, method 400 may be performed by hardware circuitry, e.g., the remote data agent alone and/or in combination with firmware and/or software.

As illustrated, method 400 begins by receiving a cache command from a memory side cache controller (block 410). Next at block 420, the remote data agent may access the data array based on the cache command. For example, data may be read and provided to an IP circuit requester (potentially in combination with writing the data, if received from the memory side controller, to the data array). Next at block 430, the data may be communicated with the IP circuit with read data being sent to the IP circuit and write data (e.g., in response to a write pull) being obtained and written into the data array. Finally, at optional block 440, a completion for the transaction can be sent to the memory side cache controller. Of course, additional and different operations are possible in other embodiments. Furthermore, the ordering of the sending/receiving data may occur in different orders for write and read operations. For example, in the case of a write, the data is received from the IP circuit before it is written to the data array.

### Example Computer Architectures.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

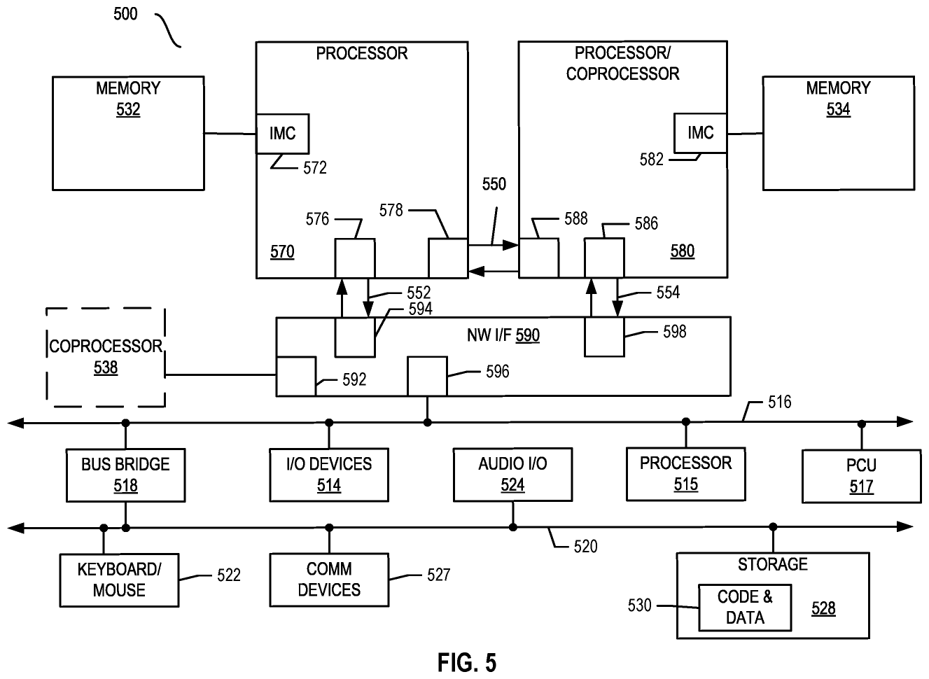

FIG. 5 illustrates an example computing system. Multiprocessor system 500 is an interfaced system and includes a plurality of processors or cores including a first processor 570 and a second processor 580 coupled via an interface 550 such as a point-to-point (P-P) interconnect, a fabric, and/or bus. One or more of the cores may include hardware support for performing instructions. In some examples, the first processor 570 and the second processor 580 are homogeneous. In some examples, first processor 570 and the second processor 580 are heterogenous. Though the example system 500 is shown to have two processors, the system may have three or more processors, or may be a single processor system. In some examples, the computing system is a SoC.

Processors 570 and 580 are shown including integrated memory controller (IMC) circuitry 572 and 582, respectively. Processor 570 also includes interface circuits 576 and 578; similarly, second processor 580 includes interface circuits 586 and 588. Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface (NW I/F) 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface circuit 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A memory side cache (not separately shown) may be included in either processor 570, 580 or outside of both processors, yet connected with the processors via an interface such as P-P interconnect. The MS$ may include disaggregated cache control circuitry and data array as described herein.

Network interface 590 may be coupled to a first interface 516 via interface circuit 596. In some examples, first interface 516 may be an interface such as a Peripheral Component Interconnect (PCI) interconnect, a PCI Express interconnect or another I/O interconnect. In some examples, first interface 516 is coupled to a power control unit (PCU) 517, which may include circuitry, software, and/or firmware to perform power management operations with regard to the processors 570, 580 and/or co-processor 538. PCU 517 provides control information to a voltage regulator (not shown) to cause the voltage regulator to generate the appropriate regulated voltage. PCU 517 also provides control information to control the operating voltage generated. In various examples, PCU 517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 517 is illustrated as being present as logic separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and storage circuitry 528. Storage circuitry 528 may be one or more non-transitory machine-readable storage media as described below, such as a disk drive or other mass storage device which may include instructions/code and data 530 and may implement the storage 303 in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Understand that the terms “system on chip” or “SoC” are to be broadly construed to mean an integrated circuit having one or more semiconductor dies implemented in a package, whether a single die, a plurality of dies on a common substrate, or a plurality of dies at least some of which are in stacked relation. Thus as used herein, such SoCs are contemplated to include separate chiplets, dielets, and/or tiles, and the terms “system in package” and “SiP” are interchangeable with system on chip and SoC. Example core architectures are described next, followed by descriptions of example processors and computer architectures.

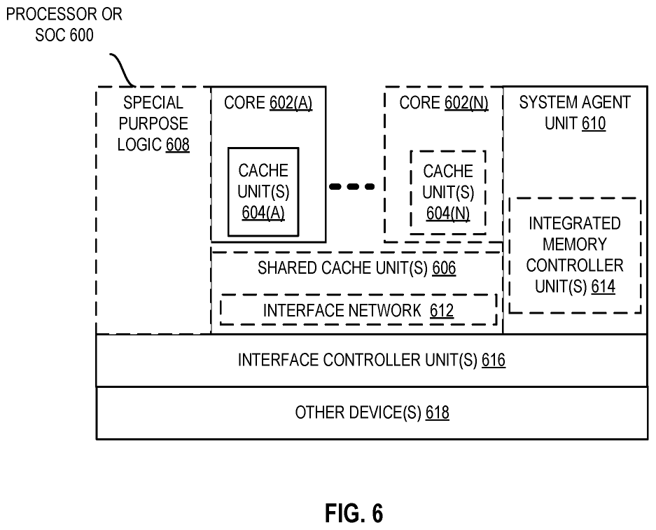

FIG. 6 illustrates a block diagram of an example processor and/or SoC 600 that may have one or more cores and an integrated memory controller. The solid lined boxes illustrate a processor 600 with a single core 602(A), system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or co-processor 538 or 515 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (including a disaggregated memory side cache as described herein) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as a last level cache (LLC), and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller units circuitry 616 couple the cores 602 to one or more other devices 618 such as one or more I/O devices, storage, one or more communication devices (e.g., wireless networking, wired networking, etc.), etc.

The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

### Example Core Architectures—In-Order and Out-of-Order Core Block Diagram.

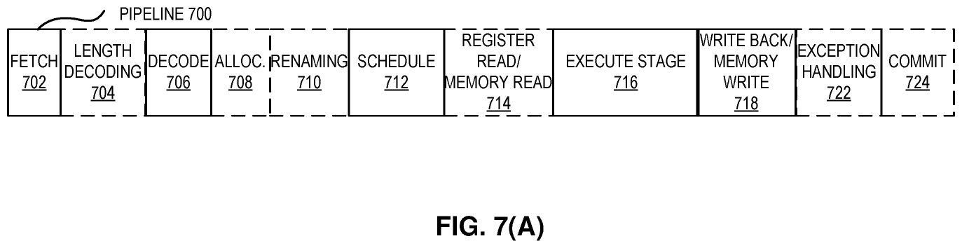

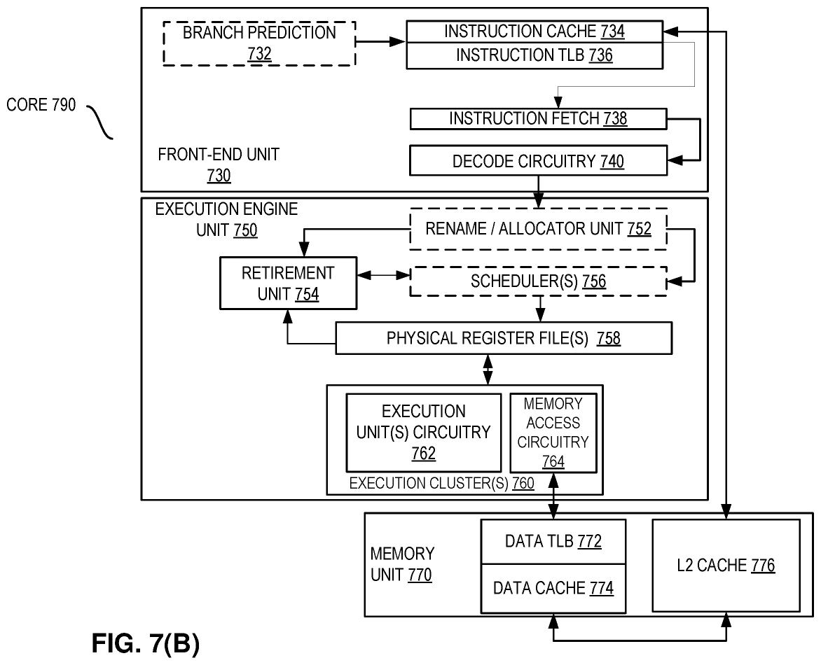

FIG. 7(A) is a block diagram illustrating both an example in-order pipeline and an example register renaming, out-of-order issue/execution pipeline according to examples. FIG. 7(B) is a block diagram illustrating both an example in-order architecture core and an example register renaming, out-of-order issue/execution architecture core to be included in a processor according to examples. The solid lined boxes in FIGS. 7(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7(A), a processor pipeline 700 includes a fetch stage 702, an optional length decoding stage 704, a decode stage 706, an optional allocation (Alloc) stage 708, an optional renaming stage 710, a schedule (also known as a dispatch or issue) stage 712, an optional register read/memory read stage 714, an execute stage 716, a write back/memory write stage 718, an optional exception handling stage 722, and an optional commit stage 724. One or more operations can be performed in each of these processor pipeline stages. For example, during the fetch stage 702, one or more instructions are fetched from instruction memory, and during the decode stage 706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 706 and the register read/memory read stage 714 may be combined into one pipeline stage. In one example, during the execute stage 716, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 7(B) may implement the pipeline 700 as follows: 1) the instruction fetch circuitry 738 performs the fetch and length decoding stages 702 and 704; 2) the decode circuitry 740 performs the decode stage 706; 3) the rename/allocator unit circuitry 752 performs the allocation stage 708 and renaming stage 710; 4) the scheduler(s) circuitry 756 performs the schedule stage 712; 5) the physical register file(s) circuitry 758 and the memory unit circuitry 770 perform the register read/memory read stage 714; the execution cluster(s) 760 perform the execute stage 716; 6) the memory unit circuitry 770 and the physical register file(s) circuitry 758 perform the write back/memory write stage 718; 7) various circuitry may be involved in the exception handling stage 722; and 8) the retirement unit circuitry 754 and the physical register file(s) circuitry 758 perform the commit stage 724.

FIG. 7(B) shows a processor core 790 including front-end unit circuitry 730 coupled to execution engine unit circuitry 750, and both are coupled to memory unit circuitry 770. The core 790 may be a reduced instruction set architecture computing (RISC) core, a complex instruction set architecture computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front-end unit circuitry 730 may include branch prediction circuitry 732 coupled to instruction cache circuitry 734, which is coupled to an instruction translation lookaside buffer (TLB) 736, which is coupled to instruction fetch circuitry 738, which is coupled to decode circuitry 740. In one example, the instruction cache circuitry 734 is included in the memory unit circuitry 770 rather than the front-end circuitry 730. The decode circuitry 740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 740 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 740 may be implemented using various different mechanisms. Examples of suitable mechanisms include, but are not limited to, look-up tables, hardware implementations, programmable logic arrays (PLAs), microcode read only memories (ROMs), etc. In one example, the core 790 includes a microcode ROM (not shown) or other medium that stores microcode for certain macroinstructions (e.g., in decode circuitry 740 or otherwise within the front-end circuitry 730). In one example, the decode circuitry 740 includes a micro-operation (micro-op) or operation cache (not shown) to hold/cache decoded operations, micro-tags, or micro-operations generated during the decode or other stages of the processor pipeline 700. The decode circuitry 740 may be coupled to rename/allocator unit circuitry 752 in the execution engine circuitry 750.

The execution engine circuitry 750 includes the rename/allocator unit circuitry 752 coupled to retirement unit circuitry 754 and a set of one or more scheduler(s) circuitry 756. The scheduler(s) circuitry 756 represents any number of different schedulers, including reservations stations, central instruction window, etc. In some examples, the scheduler(s) circuitry 756 can include arithmetic logic unit (ALU) scheduler/scheduling circuitry, ALU queues, address generation unit (AGU) scheduler/scheduling circuitry, AGU queues, etc. The scheduler(s) circuitry 756 is coupled to the physical register file(s) circuitry 758. Each of the physical register file(s) circuitry 758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 758 includes vector registers unit circuitry, writemask registers unit circuitry, and scalar register unit circuitry, and includes one or more concurrent interval register files, in addition to a common register file, as described herein. These register units may provide architectural vector registers, vector mask registers, general-purpose registers, etc. The physical register file(s) circuitry 758 is coupled to the retirement unit circuitry 754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 754 and the physical register file(s) circuitry 758 are coupled to the execution cluster(s) 760. The execution cluster(s) 760 includes a set of one or more execution unit(s) circuitry 762 and a set of one or more memory access circuitry 764. The execution unit(s) circuitry 762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 756, physical register file(s) circuitry 758, and execution cluster(s) 760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 764). It should also be understood that where separate pipelines are used, one or more of these pipelines may be out-of-order issue/execution and the rest in-order.

In some examples, the execution engine unit circuitry 750 may perform load store unit (LSU) address/data pipelining to an Advanced Microcontroller Bus (AMB) interface (not shown), and address phase and writeback, data phase load, store, and branches.

The set of memory access circuitry 764 is coupled to the memory unit circuitry 770, which includes data TLB circuitry 772 coupled to data cache circuitry 774 coupled to level 2 (L2) cache circuitry 776. In one example, the memory access circuitry 764 may include load unit circuitry, store address unit circuitry, and store data unit circuitry, each of which is coupled to the data TLB circuitry 772 in the memory unit circuitry 770. The instruction cache circuitry 734 is further coupled to the level 2 (L2) cache circuitry 776 in the memory unit circuitry 770. In one example, the instruction cache 734 and the data cache 774 are combined into a single instruction and data cache (not shown) in L2 cache circuitry 776, level 3 (L3) cache circuitry (not shown), and/or main memory. The L2 cache circuitry 776 is coupled to one or more other levels of cache including a disaggregated memory side cache in accordance with an embodiment, and eventually to a main memory.

The core 790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 790 includes logic to support a packed data instruction set architecture extension (e.g., AVX1, AVX2), thereby allowing the operations used by many multimedia applications to be performed using packed data.

### Example Execution Unit(s) Circuitry.

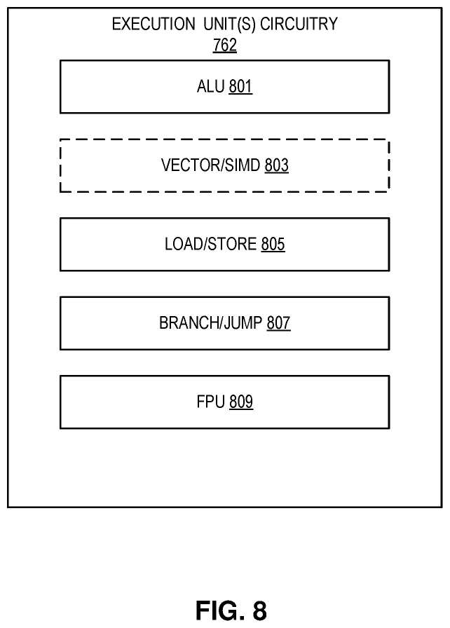

FIG. 8 illustrates examples of execution unit(s) circuitry, such as execution unit(s) circuitry 762 of FIG. 7(B). As illustrated, execution unit(s) circuitry 762 may include one or more ALU circuits 801, optional vector/single instruction multiple data (SIMD) circuits 803, load/store circuits 805, branch/jump circuits 807, and/or Floating-point unit (FPU) circuits 809. ALU circuits 801 perform integer arithmetic and/or Boolean operations. Vector/SIMD circuits 803 perform vector/SIMD operations on packed data (such as SIMD/vector registers). Load/store circuits 805 execute load and store instructions to load data from memory into registers or store from registers to memory. Load/store circuits 805 may also generate addresses. Branch/jump circuits 807 cause a branch or jump to a memory address depending on the instruction. FPU circuits 809 perform floating-point arithmetic. The width of the execution unit(s) circuitry 762 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

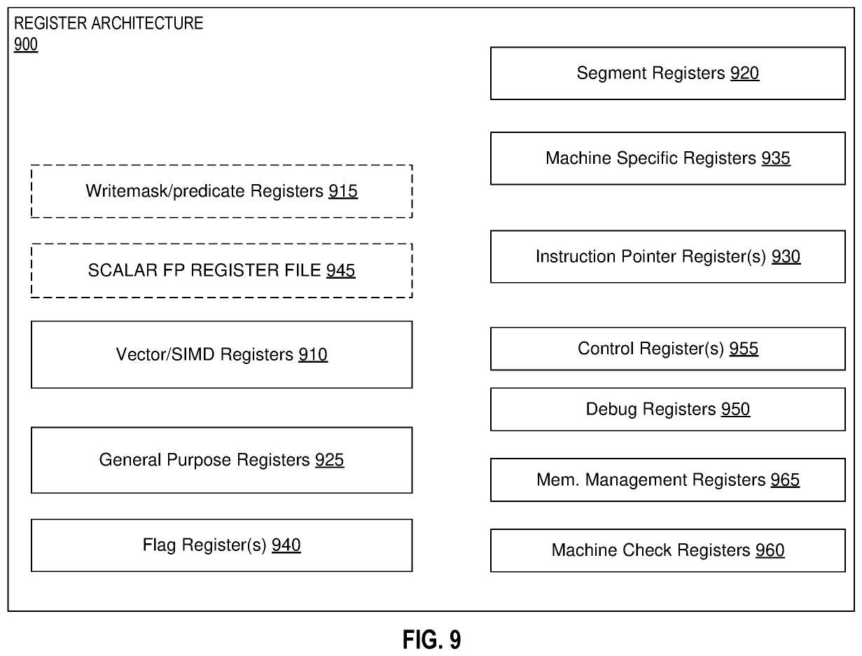

FIG. 9 is a block diagram of a register architecture 900 according to some examples. As illustrated, the register architecture 900 includes vector/SIMD registers 910 that vary from 128-bit to 1,024 bits width. In some examples, the vector/SIMD registers 910 are physically 512-bits and, depending upon the mapping, only some of the lower bits are used. For example, in some examples, the vector/SIMD registers 910 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 900 includes writemask/predicate registers 915. For example, in some examples, there are 8 writemask/predicate registers (sometimes called k0 through k7) that are each 16-bit, 32-bit, 64-bit, or 128-bit in size. Writemask/predicate registers 915 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 915 corresponds to a data element position of the destination. In other examples, the writemask/predicate registers 915 are scalable and consists of a set number of enable bits for a given vector element (e.g., 8 enable bits per 64-bit vector element).

The register architecture 900 includes a plurality of general-purpose registers 925. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 900 includes scalar floating-point (FP) register file 945 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 940 (e.g., EFLAGS, RFLAGS, etc.) store status and control information for arithmetic, compare, and system operations. For example, the one or more flag registers 940 may store condition code information such as carry, parity, auxiliary carry, zero, sign, and overflow. In some examples, the one or more flag registers 940 are called program status and control registers.

Segment registers 920 contain segment points for use in accessing memory. In some examples, these registers are referenced by the names CS, DS, SS, ES, FS, and GS.

Machine specific registers (MSRs) 935 control and report on processor performance. Most MSRs 935 handle system-related functions and are not accessible to an application program. Machine check registers 960 consist of control, status, and error reporting MSRs that are used to detect and report on hardware errors.

One or more instruction pointer register(s) 930 store an instruction pointer value. Control register(s) 955 (e.g., CR0-CR4) determine the operating mode of a processor (e.g., processor 570, 580, 538, 515, and/or 600) and the characteristics of a currently executing task. Debug registers 950 control and allow for the monitoring of a processor or core's debugging operations.

Memory (mem) management registers 965 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 900 may, for example, be used in register file/memory 308, or physical register file(s) circuitry 758.

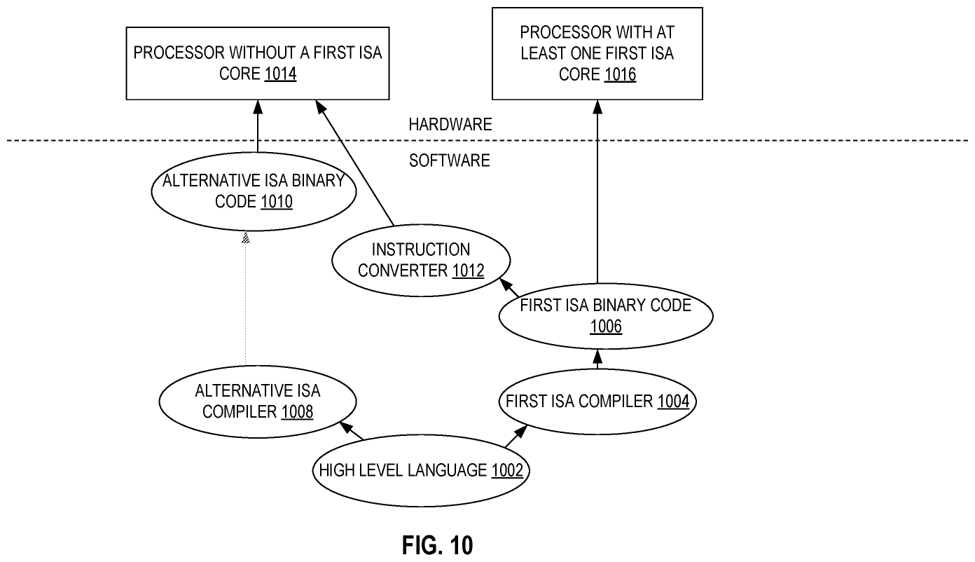

FIG. 10 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 10 shows a program in a high-level language 1002 may be compiled using a first ISA compiler 1004 to generate first ISA binary code 1006 that may be natively executed by a processor with at least one first ISA core 1016. The processor with at least one first ISA core 1016 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1004 represents a compiler that is operable to generate first ISA binary code 1006 (e.g., object code) that can, with or without additional linkage processing, be executed on the processor with at least one first ISA core 1016. Similarly, FIG. 10 shows the program in the high-level language 1002 may be compiled using an alternative ISA compiler 1008 to generate alternative ISA binary code 1010 that may be natively executed by a processor without a first ISA core 1014. The instruction converter 1012 is used to convert the first ISA binary code 1006 into code that may be natively executed by the processor without a first ISA core 1014. This converted code is not necessarily to be the same as the alternative ISA binary code 1010; however, the converted code will accomplish the general operation and be made up of instructions from the alternative ISA. Thus, the instruction converter 1012 represents software, firmware, hardware, or a combination thereof that, through emulation, simulation or any other process, allows a processor or other electronic device that does not have a first ISA processor or core to execute the first ISA binary code 1006.

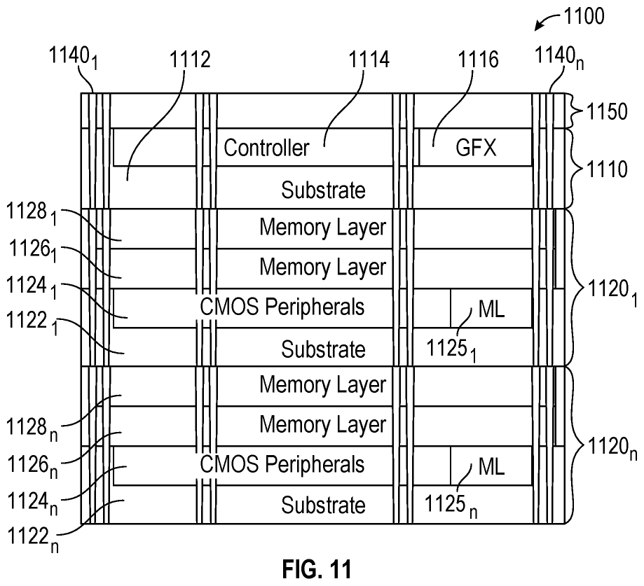

Referring now to FIG. 11, shown is a cross sectional view of a package in accordance with an embodiment. As shown in FIG. 11, package 1100 is a multi-die package including a set of stacked die, namely a first die 1110, which may be a compute die and multiple memory die 1120₁ and 1120₂ that may form at least a portion of a disaggregated memory side cache. With this stacked arrangement, compute die 1110 (which may include a memory side cache memory controller) may be stacked above memory die 1120 such that localized connectivity is realized between corresponding portions of memory die 1120 and compute die 1110. As further illustrated, a package substrate 1150 may be present onto which the stacked dies may be adapted. In an embodiment, compute die 1110 may be adapted at the top of the stack to improve cooling.

As further illustrated in FIG. 11, physical interconnection between circuitry present on the different die may be realized by through silicon vias (TSVs) 1140₁-1140ₙ (each of which may be formed of independent TSVs of each die). As shown, with respect to compute die 1110, a substrate 1112 is provided in which controller circuitry 1114 and graphics circuitry 1116 is present.

With reference to memory die 1120, a substrate 1122 is present in which complementary metal oxide semiconductor (CMOS) peripheral circuitry 1124 may be implemented, along with memory logic (ML) 1125, which may include one or more RDAs as described herein.

As shown, memory die 1120 may include memory layers 1126, 1128. While shown with two layers in this example, understand that more layers may be present in other implementations. Note that memory die 1120 may be implemented in a manner in which the memory circuitry of layers 1126, 1128 may be implemented with backend of line (BEOL) techniques. While shown at this high level in FIG. 11, many variations and alternatives are possible.

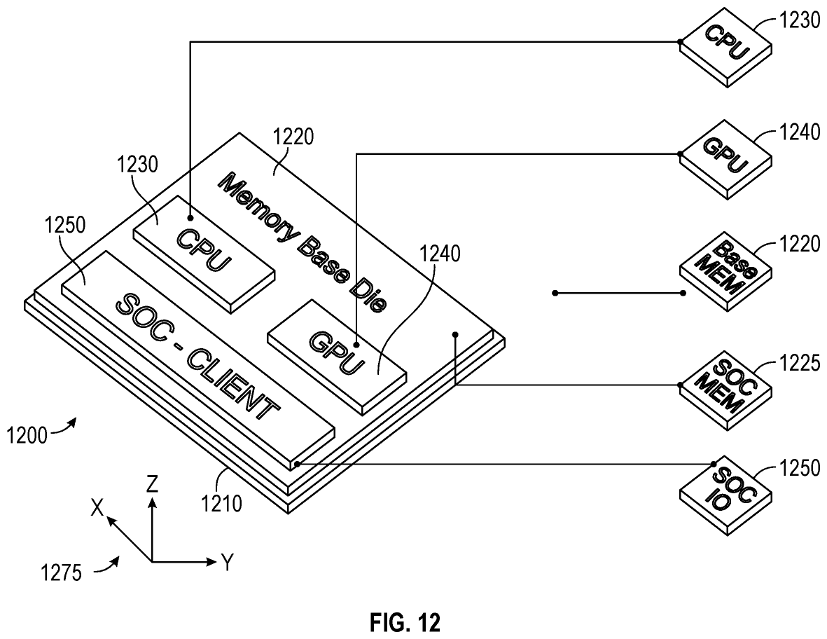

Referring now to FIG. 12, shown is a block diagram of a scalable integrated circuit (IC) package in accordance with an embodiment. As shown in FIG. 12, package 1200 is shown in an opened state; that is, without an actual package adapted about the various circuitry present. In the high level shown in FIG. 12, package 1200 is implemented as a multi-die package having a plurality of dies adapted on a substrate 1210. Substrate 1210 may be a glass or sapphire substrate and may, in some cases, include interconnect circuitry to couple various dies within package 1200 and to further couple to components external to package 1200.

In the illustration of FIG. 12, a memory die 1220 is adapted on substrate 1210. In embodiments herein, memory die 1220 may be a disaggregated memory side cache that is arranged according to an embodiment herein.

As further shown in FIG. 12, multiple dies may be adapted above memory die 1220. As shown, a central processing unit (CPU) die 1230, a graphics (graphics processing unit (GPU)) die 1240, and a SoC die 1250 all may be adapted on memory die 1220. FIG. 12 further shows in inset these disaggregated dies, prior to adaptation in package 1200. CPU die 1230 and GPU die 1240 may include a plurality of general-purpose processing cores and graphics processing cores, respectively. In some use cases, instead of a graphics die, another type of specialized processing unit (generically referred to as an “XPU”) may be present. Regardless of the specific compute dies present, each of these cores may locally and directly couple to a corresponding portion of memory die 1220, e.g., by way of TSVs. In addition, CPU die 1230 and GPU die 1240 may communicate via interconnect circuitry. Similarly, additional circuitry of an SoC, including interface circuitry to interface with other ICs or other components of a system may occur via circuitry of SoC die 1250.

While shown with a single CPU die and single GPU die, in other implementations multiple ones of one or both of CPU and GPU dies may be present. More generally, different numbers of CPU and XPU dies (or other heterogenous dies) may be present in a given implementation.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

The following examples pertain to further embodiments.

In one example, an apparatus includes multiple dies, with at least: a first die comprising: a plurality of cores; and memory circuitry comprising a memory controller and a memory side cache controller to maintain tag information and state information for a data array; and a second die coupled to the first die, the second die comprising: the data array to cache data for at least one accelerator, the at least one accelerator remote from the first die, where the memory side cache controller is to control the data array. In an example, the second die further comprises the at least one accelerator.

In an example, the apparatus further comprises a third die comprising the at least one accelerator, where the third die is stacked on the second die.

In an example, the apparatus further comprises a die-to-die interconnect to couple the first die and the second die, the apparatus comprising a package having the first die and the second die.

In an example, the second die further comprises a remote data agent, the remote data agent to receive cache commands from the memory side cache controller and access the data array in response to the cache commands.

In an example, in response to a read request for data from the at least one accelerator, the memory side cache controller is to identify a location of the data in the data array, and send a first cache command to the remote data agent to cause the remote data agent to access the data from the data array and directly provide the data to the at least one accelerator.

In an example, the remote data agent is to send a completion to the memory side cache controller after the data is provided to the at least one accelerator.

In an example, the remote data agent is to send a completion to the memory side cache controller after the remote data agent reads the first cache command.

In an example, in response to a write request to write data from the at least one accelerator, the memory side cache controller is to: identify a location for storage of the data in the data array; and send a second cache command to the remote data agent to cause the remote data agent to write the data into the location of the data array.

In an example, in response to the second cache command, the remote data agent is to: send a write pull request to the at least one accelerator to obtain the data; and receive the data from the at least one accelerator and directly write the data into the location in the data array.

In an example, the remote data agent comprises at least one queue to store pending transactions, where the remote data agent is to maintain ordering of the pending transactions.

In an example, the memory side cache controller is to receive a request from the at least one accelerator, the request comprising a logical address, and in response to the request, send a cache command with a cache address, the cache address comprising a location in the data array corresponding to the logical address.

In another example, a method comprises: receiving, in a memory controller of a memory side cache, a request from an IP circuit, the IP circuit aggregated with a data array of the memory side cache, the memory controller of the memory side cache disaggregated from the data array of the memory side cache; determining a cache address of a location in the data array based at least in part on a logical address of the request; sending a cache command to a controller associated with the data array, to cause the controller to access data at the location in the data array.

In another example, the method further comprises: in response to identifying a miss for the read request in the data array, sending a memory read request to a memory of a memory hierarchy; receiving the data from the memory; and sending a write and forward cache command to the controller with the data to cause the controller to forward the data to the IP circuit and store the data in the location in the data array.

In an example, the method further comprises: in response to identifying a hit for the read request in the data array, sending a read and forward cache command to the controller to cause the controller to read the data from the location in the data array and forward the data to the IP circuit.

In an example, when the request comprises a write request, the method further comprises: sending a write pull cache command to the controller to cause the controller to obtain the data from the IP circuit and store the data in the location in the data array.

In an example, the method further comprises: receiving, from the controller, a completion for the cache command; and maintaining an ordering of at least one transaction based at least in part on the completion.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system includes a semiconductor package and a system memory coupled to the semiconductor package. The semiconductor package comprises: a first die comprising a plurality of cores, a memory controller for the system memory, and a memory side cache controller for a memory side cache; and a second die comprising a data array of the memory side cache and a remote data agent to perform cache commands received from the memory side cache controller, where the remote data agent comprises an interface between the data array and at least one accelerator; and the system memory coupled to the semiconductor package.

In an example, the semiconductor package further comprises a third die, the third die comprising the at least one accelerator.

In an example, the remote data agent is to receive a cache command from the memory side cache controller and in response to the cache command, is to: access data in the data array, the data located at a cache address identified in the cache command; directly provide the data to the at least one accelerator; and send a completion for the cache command to the memory side cache controller.

In yet another example, an apparatus comprises means for receiving a request from an IP circuit means, the IP circuit means aggregated with a data array means of a memory side cache means, a memory control means of the memory side cache means disaggregated from the data array means of the memory side cache means; means for determining a cache address of a location in the data array means based at least in part on a logical address of the request; means for sending a cache command to control means associated with the data array means for causing the control means to access data at the location in the data array means.

In another example, the apparatus further comprises: means for sending a memory read request to memory means of a memory hierarchy; means for receiving the data from the memory means; and means for sending a write and forward cache command to the control means with the data to cause the control means to forward the data to the IP circuit means and store the data in the location in the data array means.

In an example, the apparatus further comprises: means for sending a read and forward cache command to the control means to cause the control means to read the data from the location in the data array means and forward the data to the IP circuit means.

In an example, the apparatus further comprises: means for sending a write pull cache command to the control means to cause the control means to obtain the data from the IP circuit means and store the data in the location in the data array means.

In an example, the apparatus further comprises: means for receiving a completion for the cache command; and means for maintaining an ordering of at least one transaction based at least in part on the completion.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SOC or other processor, is to configure the SOC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
a first die comprising:
a plurality of cores; and
memory circuitry comprising a memory controller and a memory side cache controller to maintain tag information and state information for a data array; and
a second die coupled to the first die, the second die comprising:
the data array to cache data for at least one accelerator, the at least one accelerator remote from the first die, wherein the memory side cache controller is to control the data array.

2. The apparatus of claim 1, wherein the second die further comprises the at least one accelerator.

3. The apparatus of claim 1, further comprising a third die comprising the at least one accelerator, wherein the third die is stacked on the second die.

4. The apparatus of claim 1, further comprising a die-to-die interconnect to couple the first die and the second die, the apparatus comprising a package having the first die and the second die.

5. The apparatus of claim 1, wherein the second die further comprises a remote data agent, the remote data agent to receive cache commands from the memory side cache controller and access the data array in response to the cache commands.

6. The apparatus of claim 5, wherein, in response to a read request for data from the at least one accelerator, the memory side cache controller is to identify a location of the data in the data array, and send a first cache command to the remote data agent to cause the remote data agent to access the data from the data array and directly provide the data to the at least one accelerator.

7. The apparatus of claim 6, wherein the remote data agent is to send a completion to the memory side cache controller after the data is provided to the at least one accelerator.

8. The apparatus of claim 6, wherein the remote data agent is to send a completion to the memory side cache controller after the remote data agent reads the first cache command.

9. The apparatus of claim 5, wherein, in response to a write request to write data from the at least one accelerator, the memory side cache controller is to:
identify a location for storage of the data in the data array; and
send a second cache command to the remote data agent to cause the remote data agent to write the data into the location of the data array.

10. The apparatus of claim 9, wherein, in response to the second cache command, the remote data agent is to:
send a write pull request to the at least one accelerator to obtain the data; and
receive the data from the at least one accelerator and directly write the data into the location in the data array.

11. The apparatus of claim 5, wherein the remote data agent comprises at least one queue to store pending transactions, wherein the remote data agent is to maintain ordering of the pending transactions.

12. The apparatus of claim 1, wherein the memory side cache controller is to receive a request from the at least one accelerator, the request comprising a logical address, and in response to the request, send a cache command with a cache address, the cache address comprising a location in the data array corresponding to the logical address.

13. At least one computer readable medium comprising instructions, which when executed by a processor, cause the processor to execute a method comprising:
receiving, in a memory controller of a memory side cache, a request from an intellectual property (IP) circuit, the IP circuit aggregated with a data array of the memory side cache, the memory controller of the memory side cache disaggregated from the data array of the memory side cache;
determining a cache address of a location in the data array based at least in part on a logical address of the request;
sending a cache command to a controller associated with the data array, to cause the controller to access data at the location in the data array.

14. The at least one computer readable medium of claim 13, wherein when the request comprises a read request, the method further comprises:
in response to identifying a miss for the read request in the data array, sending a memory read request to a memory of a memory hierarchy;
receiving the data from the memory; and
sending a write and forward cache command to the controller with the data to cause the controller to forward the data to the IP circuit and store the data in the location in the data array.

15. The at least one computer readable medium of claim 13, wherein when the request comprises a read request, the method further comprises:
in response to identifying a hit for the read request in the data array, sending a read and forward cache command to the controller to cause the controller to read the data from the location in the data array and forward the data to the IP circuit.

16. The at least one computer readable medium of claim 13, wherein when the request comprises a write request, the method further comprises:
sending a write pull cache command to the controller to cause the controller to obtain the data from the IP circuit and store the data in the location in the data array.

17. The at least one computer readable medium of claim 13, wherein the method further comprises:
receiving, from the controller, a completion for the cache command; and
maintaining an ordering of at least one transaction based at least in part on the completion.

18. A system comprising:
a semiconductor package comprising:
a first die comprising a plurality of cores, a memory controller for a system memory, and a memory side cache controller for a memory side cache; and
a second die comprising a data array of the memory side cache and a remote data agent to perform cache commands received from the memory side cache controller, wherein the remote data agent comprises an interface between the data array and at least one accelerator; and
the system memory coupled to the semiconductor package.

19. The system of claim 18, wherein the semiconductor package further comprises a third die, the third die comprising the at least one accelerator.

20. The system of claim 18, wherein the remote data agent is to receive a cache command from the memory side cache controller and in response to the cache command, is to:
access data in the data array, the data located at a cache address identified in the cache command;
directly provide the data to the at least one accelerator; and
send a completion for the cache command to the memory side cache controller.
